(19) United States
(12) Patent Application Publication
(10) Pub. No.: US 2025/0193246 A1
(43) Pub. Date: Jun. 12, 2025

(54) SECURITY RULE CONVERSION AND PERFORMANCE EVALUATION

(71) Applicant: Palo Alto Networks, Inc., Santa Clara, CA (US)

(72) Inventors: Lexuan Sun, Sunnyvale, CA (US); Li Qiu, Milpitas, CA (US); Mengying Jiang, Campbell, CA (US); Shengming Xu, San Jose, CA (US)

(21) Appl. No.: 18/533,943

(22) Filed: Dec. 8, 2023

(51) Int. Cl. H04L 9/40

(52) U.S. Cl. CPC H04L 63/20; H04L 63/1425

(57) ABSTRACT

A cybersecurity rule conversion system (“conversion system”) disclosed herein converts IPS/IDS rules from existing formats to target formats in a pipeline that ensures quality of resulting converted rules. First, the conversion system identifies and validates existing rule formats. For rules with validated existing formats, the conversion system maps tokens in the existing format to tokens in the target format and populates a converted rule in the target format. The conversion system then evaluates and tunes patterns in the converted rules for matching range and length. Finally, the conversion system evaluates the converted rules for performance on traffic logs and for quality of patterns and matching ranges of patterns therein, and exports the converted rules to users with indications of performance deficiencies.

### BACKGROUND

The disclosure generally relates to transmission of digital information (e.g., CPC H04L) and managing network security (e.g., CPC subclass H04L 63/20).

Intrusion detection systems use a behavior-based approach and/or a signature-based approach. For the behavior-based approach, a machine learning model is typically employed to detect anomalous behavior of network traffic. For the signature-based approach, rules are typically defined to detect a cyberattack signature. A rule is written with traffic matching criteria defined with various rule components, such as a text pattern and a specified communication or application protocol. Along with increasing variations in cyberattacks, a ruleset for detecting these attacks also increases in number of rules. An intrusion detection system ruleset can easily include several thousand rules. In addition, different signature-based solutions for an intrusion detection system have different rule syntax. Thus, manual ruleset management has been at least partially displaced by automated ruleset management.

### BRIEF DESCRIPTION OF THE DRAWINGS

Embodiments of the disclosure may be better understood by referencing the accompanying drawings.

FIG. 1 depicts an example cybersecurity rule conversion system with a format validation, conversion, and performance evaluation pipeline.

FIG. 2 is a flowchart of example operations for converting security rules between rule formats with token/pattern mappings and evaluating converted security rules.

FIG. 3 is a flowchart of example operations for converting a security rule from an existing format to a target format with token/pattern mappings.

FIG. 4 depicts an example computer system with a cybersecurity rule conversion system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Different cybersecurity vendors can implement different intrusion prevention system (IPS)/intrusion detection system (IDS) rules that define security policies for security appliances. Users transitioning between vendors may want to convert rules from an existing format to a target format, and the rules to convert can number in the tens or hundreds or thousands. The different vendors can provide more or less rule options (e.g., types of fields for particular protocols) comparatively and therefore it can be difficult to automatically infer a mapping of a first rule for a first rule format of a first cybersecurity vendor to a second rule of a second rule format for a second cybersecurity vendor. This difficulty is compounded by the inclusion of regular expressions for certain rules and differing formats to express rules for each vendor. Post rule conversion, the resulting converted rules need to be tested for performance to determine whether malicious traffic detected pre-conversion is still detected post-conversion. This includes determining whether scopes of the converted rules are correct and whether they are detecting too many false positive protocol data units (PDUs) or too many false negative PDUs in traffic logs.

A cybersecurity rule conversion system (“conversion system”) presented herein identifies and validates rule formats, converts rules, and checks rule performance post conversion. Rules that fail performance checks can be updated accordingly and reevaluated until they pass performance checks, at which point they are exported for implementation on a security appliance(s). At the rule format validation stage, the conversion system identifies a rule format (e.g., SNORT® rules, SURICATA® rules, etc.) and validates syntax of the rule format according to known syntax of rule formats. The conversion system generates an error/warning report for rules having invalid syntax and ceases the remainder of the conversion pipeline. After format validation, the conversion system extracts and maps tokens indicating metadata (e.g., type of field for a protocol) of patterns in rules to a target format according to predefined mappings. The conversion system tunes the converted rules by shortening long patterns and/or lengthening short patterns and tuning a “matching range” of certain patterns, where “matching range” refers to a set of protocol fields where the patterns are matched when the rule is applied. Finally, at the performance check stage, the conversion system evaluates converted rules by determining scope of patterns therein and performance of the converted rules on traffic logs for known malicious/benign traffic. If the converted rules fail the performance evaluation, the conversion system can update the converted rules and/or notify a user of possible deficiencies for the rules such as patterns that are too long or short. This cycle occurs until the resulting converted rules pass the performance evaluation and/or user criteria for implementing rules, at which point the conversion system performs a coverage check of the converted rules prior to exporting them for implementation. The disclosed methodology for rule conversion provides an automated pipeline for rule conversion that ensures high quality converted rules with both testing and updating in the case of performance failure.

### Example Illustrations

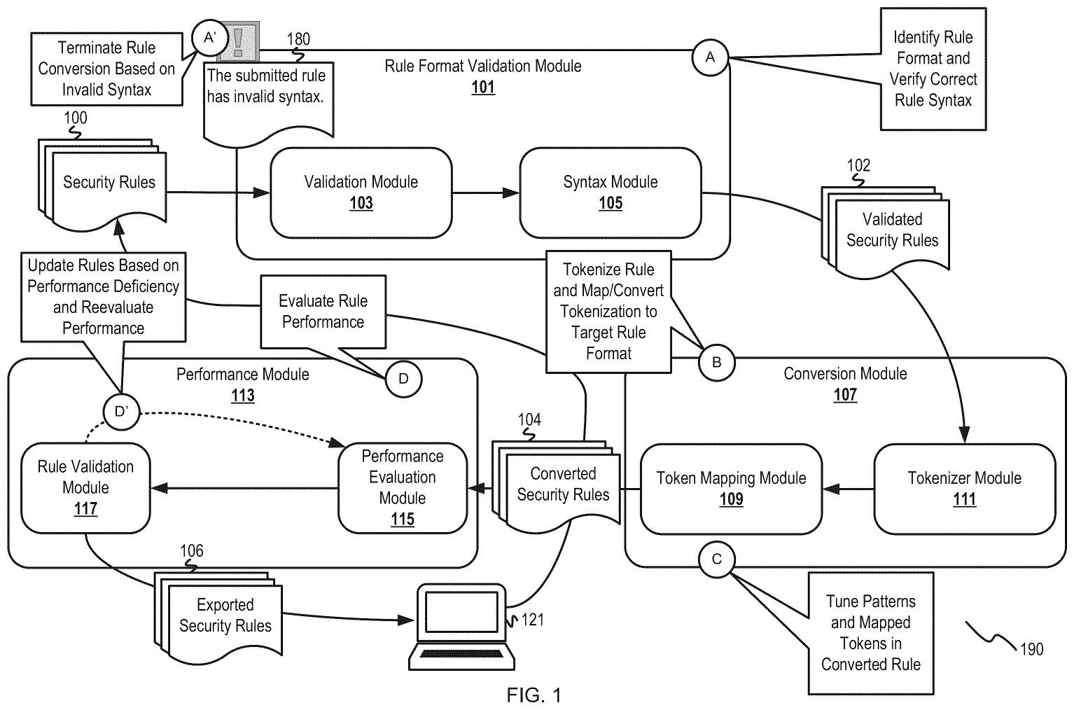

FIG. 1 depicts an example cybersecurity rule conversion system with a format validation, conversion, and performance evaluation pipeline. A cybersecurity rule conversion system (“conversion system”) 190 comprises a rule format validation module (“validation module”) 101, a conversion module 107, and a performance module 113 that collectively implement a pipeline for converting security rules for IPS/IDS systems. The validation module 101 identifies formats for security rules 100 to be converted (e.g., formats codified by cybersecurity vendors that manage cybersecurity appliances having rules with those formats) and determines whether syntax for the identified formats is correct. If the syntax is incorrect, the validation module 101 terminates operations in the pipeline and generates a user alert to a user interface 121 that indicates a corresponding rule in the security rules 100 has invalid syntax for its identified format. If the syntax is correct, the validation module 101 communicates validated security rules 102 to the conversion module 107. The conversion module 107 maps tokens in the validated security rules 102 to tokens for a target format to obtain converted security rules 104 and tunes the converted security rules 104. The conversion module 107 communicates the converted security rules 104 to the performance module 113. The performance module 113 tests the converted security rules 104 against traffic logs with a performance evaluation module 115 and tests patterns in the converted security rules 104 with a rule validation module 117. Based on failing tests, the performance module 113 can update and retest the converted security rules 104 and/or can communicate an indication to the user interface 121 of potential shortcomings for the converted security rules 104. Subsequently, the performance module exports the converted security rules 104 as exported security rules 106 to the user interface 121.

FIG. 1 is annotated with a series of letters A, A′, B-D, and D′. Each stage represents one or more operations. Although these stages are ordered for this example, the stages illustrate one example to aid in understanding this disclosure and should not be used to limit the claims. Subject matter falling within the scope of the claims can vary from what is illustrated. Stage A′ represents an optional stage that can occur after stage A and that, when triggered, terminates the operations at remaining stages. Stage D′ represents an optional stage that can occur prior to exporting rules and that triggers another instantiation of operations at stage D.

A stage A, the validation module 101 receives the security rules 100 from the user interface 121 at a validation module 103, wherein the security rules 100 comprise both the rules themselves and indications of a target rule format (e.g., an identifier of a cybersecurity vendor that supports the target rule format). The validation module 103 identifies formats of the security rules 100. As an illustrative example for formats of the security rules 100, SNORT and SURICATA rules comprise an action that determines an action to perform when the rules match traffic logs, a header that defines where to apply the rules (e.g., protocols, Internet Protocol (IP) addresses, ports, directions, etc.), and rule options that at least define patterns and corresponding protocol fields for the rules. The validation module 103 can parse the security rules 100 to identify a first token that indicates an action, subsequent tokens that indicate a header, subsequent tokens that indicate rule options, and patterns corresponding to at least a subset of the rule options. For instance, for SNORT, the validation module 103 can identify rule options as being between “(” and “)” characters, separated by “;” characters, with options/patterns separated by a “:” character (i.e., parenthesis, semicolons, and colons, respectively). The validation module 101 can maintain an index of tokens identifying actions/headers/rule options specific to supported rule formats and can match extracted tokens to the index. In some embodiments, the validation module 103 may not be able to extract tokens or match extracted tokens of the security rules 100 to identify actions, headers, and rule options and operations in these embodiments can proceed to stage A′. Additionally, the validation module 103 may not be able to parse syntax of the security rules 100 to identify a format and can, in these instances, proceed to stage A′.

The validation module 103 communicates the security rules 100 and indications of formats of each of the security rules 100 to a syntax module 105. The syntax module 105 determines whether syntax of each of the security rules 100 is correct according to their corresponding formats. The syntax module 105 can iterate through tokens extracted from rules during parsing to determine whether syntax surrounding each token is correct according to whether the tokens are in the action, header, or rule options sections. To exemplify, for a SURICATA rule, the validation module 103 can inspect tokens in the header to determine whether there is a directional flow indicated and determine whether specified IP address tokens such as HOME_NET or EXTERNAL_NET are preceded by “$” characters and whether they are separated by “→” characters. If these conditions are not satisfied, the syntax module 105 can determine that the SURICATA rule has invalid syntax. The syntax module 105 can additionally determine whether extracted patterns comprise valid regular expression and, if not, indicate that a rule has invalid syntax. If the syntax module 105 determines that syntax of one or more of the security rules 100 is incorrect, operations proceed to stage A′ for those rules and operations proceed to stage B for those of the security rules 100 with correct syntax.

At stage A′, the validation module 101 terminates the rule conversion pipeline for those of the security rules 100 identified as having invalid syntax and/or for which the validation module 103 was not able to identify a format. For instance, the validation module can generate an example alert 180 to the user interface 121. The example alert 180 comprises the text “The submitted rule has invalid syntax.”

At stage B, the validation module 101 communicates the validated security rules 102 to the conversion module 107 for conversion into the converted security rules 104. A tokenizer module 111 parses the validated security rules 102 to extract tokens or receives tokens previously extracted by the validation module 101. Each token corresponds to metadata of patterns and/or of context of the validated security rules 102 such as actions, headers, and rule options mentioned in the foregoing as well as protocol fields and/or other contexts to apply patterns. The tokenizer module 111 communicates the extracted tokens to a token mapping module 109. The token mapping module 109 maps tokens in the validated security rules 102 to tokens for corresponding target rule formats. In some instances, depending on the existing and target rule formats, the mapping can comprise a one-to-one mapping of tokens, a mapping of a single token to multiple tokens, and/or a mapping of multiple tokens to a single token. The mappings are according to features offered by the corresponding rule formats. For instance, the token mapping module 109 can map a “http.uri” token for a SURICATA rule to a “http_uri” token for a SNORT rule. On the other hand, a SURICATA rule may have a “http.cookie” token that can correspond to normalized or unnormalized HyperText Transfer Protocol (“HTTP”) cookies, whereas a SNORT rule would have a “http_cookie” token for normalized HTTP cookies and a “http_raw_cookie” for unnormalized HTTP cookies. A mapping from such a SURICATA rule to such a SNORT rule would map “http.cookie” to both “http_cookie” and “http_raw_cookie”, while a mapping from such a SNORT rule to such a SURICATA rule would map “http_cookie” and “http_raw_cookie” to “http_cookie”. If a SNORT rule only had a “http_raw_cookie” token and not a “http_cookie” token, then the mapping would map the “http_raw_cookie” token to a “http.cookie” token for a SURICATA rule with the deficiency that the rule has been broadened from unnormalized HTTP cookies to all HTTP cookies.

The token mapping by the token mapping module 109 depends on how functionality is enabled for each rule format. For certain formats, multiple tokens can correspond to a particular functionality which may not be enabled in the target rule format. For instance, for a rule format with a fast pattern functionality being converted to a rule without fast pattern functionality, the rule options ‘content: “pattern”; fast_pattern: only; http_uri’ may be mapped to ‘content: “pattern”; http_uri’ in the target format (i.e., the “fast pattern” rule option token is removed during the mapping). Tokens indicating protocol fields (e.g., HTTP header fields) not supported by the target rule format may be removed entirely or mapped to a closest/best known replacement according to a mapping index maintained by the token mapping module 109. In addition to replacing/removing tokens in the target converted rule, the token mapping module 109 additionally replaces syntax with syntax for the target rule format and copies patterns into sections for corresponding mapped tokens. A token can occur multiple times within a rule and thus multiple patterns corresponding to that token can be copied by the token mapping module 109. In general, a pattern in the validated security rules 102 can be mapped to multiple instances of that pattern corresponding to multiple tokens in the converted security rules 104, and multiple occurrences of the same pattern in the validated security rules 102 can be mapped to a lesser number of instances of that pattern in the converted security rules 104 based on features supported by the existing and target rule formats.

At stage C, the token mapping module 109 tunes mapped patterns and tokens in the converted security rules 104. Tuning of patterns comprises shortening and/or lengthening patterns and can be according to operational parameters of target rule formats that indicate maximum and minimum pattern lengths or hardcoded threshold maximum and minimum pattern lengths across rule formats. For instance, a rules engine that handles rules of the target format can have minimum and maximum pattern lengths. For shortening patterns, the token mapping module 109 can split a pattern into multiple parts that each satisfy the thresholds and can generate multiple instances each comprising the corresponding token(s) and one of the split patterns. To exemplify, the token mapping module 109 can shorten ‘content: “pattern1pattern2”; http_header’ to ‘content: “pattern1”; http_header; content: “pattern2”; http_header’. Note that in this instance, shortening refers to the shortening of the pattern itself and not shortening the length of the converted rule.

For lengthening patterns, the token mapping module 109 can identify multiple related patterns and merge these patterns into a single pattern. For instance, a rule can comprise ‘flow: to_server, established; content: “User_Agent:”; http_header; content: “Android”; within: 100, http_header’. The token mapping module 109 can determine that this rule intends to match “Android” within 100 characters of “User-Agent” in the HTTP header. Accordingly, the token mapping module 109 can replace the above patterns with ‘content: “User-Agent:.{0,93} Android”; http_header’ to merge the patterns together. The {0,93} syntax of the regular expression is due to “Android” having 7 characters. The token mapping module 109 can be configured to identify “within” tokens and other tokens indicating relative pattern positions as possible instances for pattern merging.

For tuning mapped tokens in the converted rules, the token mapping module 109 analyzes each token mapping to determine whether mapped tokens can be removed to improve performance. The token mapping module 109 can additionally analyze patterns corresponding to mapped tokens to tune the matching range of the patterns. For instance, the token mapping module 109 can identify that a token corresponding to a pattern comprising the characters “User-Agent” is mapped to a matching range indicated by a Transmission Control Protocol (TCP) payload token, a HTTP header token, and a HTTP request header token. The token mapping module 109 can then determine that “User-Agent” most likely matches a HTTP request header and remove the HTTP header and TCP payload tokens and corresponding syntax.

At stage D, the conversion module 107 communicates the converted security rules 104 to the performance module 113. The performance module 113 comprises a performance evaluation module 115 that evaluates performance of the converted security rules 104 on traffic logs and a rule validation module 117 that analyzes patterns in the converted security rules 104 and ranges of tokens corresponding to the patterns to identify possible deficiencies. The performance evaluation model 115 can test the converted security rules 104 against traffic logs from industry standard network traffic and/or on traffic of a user associated with the user interface 121. The performance evaluation model 115 compares pattern matches for the converted security rules 104 and for the security rules 100 to determine a false positive rate (FPR) of patterns matched by the converted security rules 104 on the traffic logs that are not matched by the security rules 100 and a false negative rate (FNR) of patterns not matched by the converted security rules 104 that are matched by the security rules 100.

The rule validation module 117 evaluates patterns and matching ranges of tokens where the patterns are applied in the converted security rules 104. The matching ranges of tokens can, for instance, indicate fields of protocols for which the patterns are applied. The rule validation module 117 determines whether patterns are too short or too long, whether too few tokens correspond to patterns, whether patterns comprise common patterns that do not narrow matches by the converted security rules 104 (e.g., by searching for each pattern in a database or index of common patterns), etc. Depending on implementation, the performance module 113 can omit operations by the performance evaluation module 115 and/or the rule validation module 117, for instance by only performing rule validation, by only testing on industry standard traffic logs, etc.

At stage D′, based on rule performance evaluation at stage D, the performance module 113 can update the converted security rules 104 based on performance deficiency and reevaluate performance according to the operations at stage D. For instance, updating the converted security rules 104 can comprise shortening and/or lengthening of patterns and/or adding or removing tokens that correspond to each pattern according to the foregoing description. Alternatively, the performance module 113 can instead generate an alert to a user at the user interface 121 of possible deficiencies of the converted security rules 104. The alert can indicate the FPR and FNR and corresponding type of traffic logs (e.g., a high FPR indicates that patterns are potentially too broad) and can indicate patterns that are potentially too long or too short. Subsequently, the performance module 113 formats the converted security rules 104 as exported security rules 106 (e.g., based on a proprietary data format for security rules corresponding to the target format) and communicates the exported security rules 106 to the user interface 121.

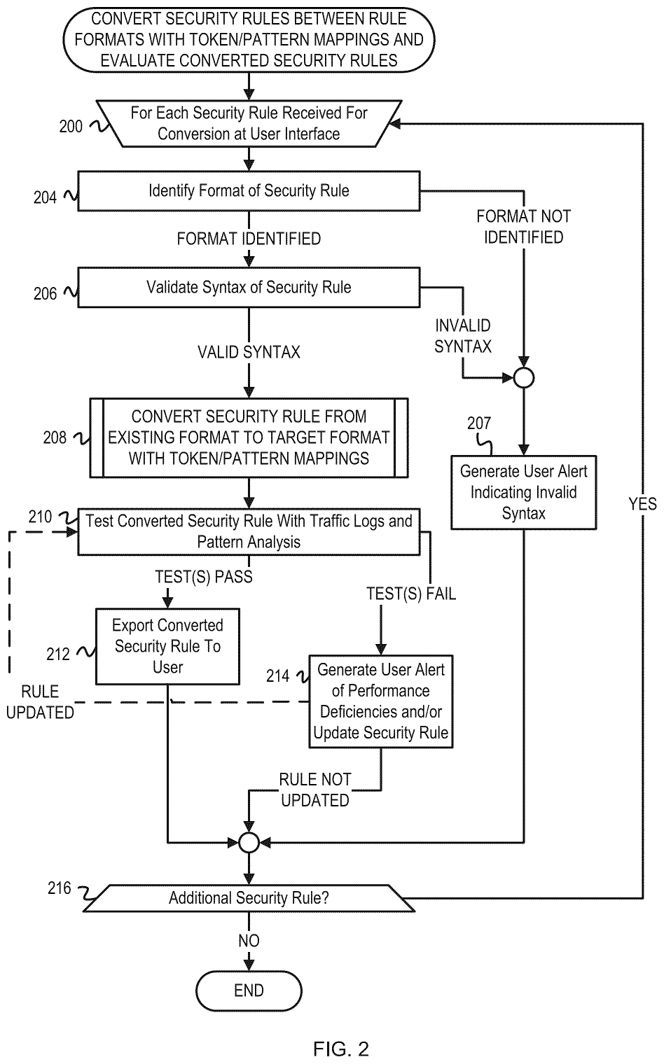

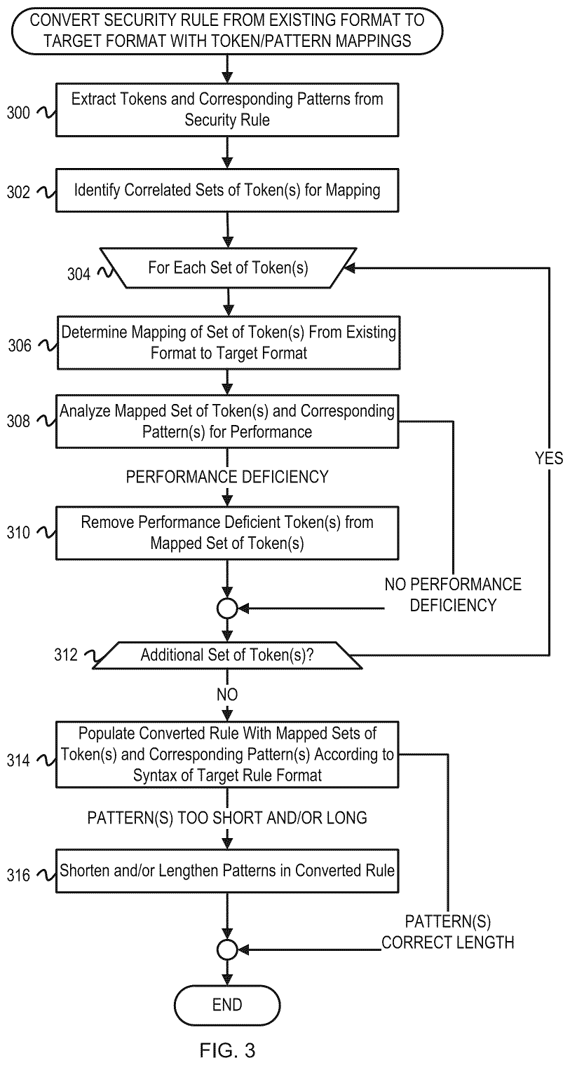

FIGS. 2-3 are flowcharts of example operations for converting and evaluating security rules based on mappings of tokens and patterns extracted from the security rules. The example operations are described with reference to a cybersecurity rule conversion system (“conversion system”) for consistency with the earlier figure and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for converting security rules between rule formats with token/pattern mappings and evaluating converted security rules. At block 200, the conversion system begins iterating through security rules received for conversion at a user interface. The conversion system can be configured to receive security rules according to a schedule (e.g., every hour, every day, etc.), in a buffer as they are communicated via the user interface, etc. Operations for each security rule can occur asynchronously and/or in parallel. Each received security rule comprises an indication of a target rule format for conversion.

At block 204, the conversion system identifies a format of the security rule. The conversion system can identify the format of the security rule according to syntax and/or tokens therein. For instance, the conversion system can identify an action, a header, and/or rule options in the security rule. The conversion system can then match tokens in the security rule with an index of tokens unique to various formats of security rules supported by the conversion system. Alternatively, the conversion system can identify syntax such as particular characters in the action, header, and/or rule options and can determine that syntax is unique to a particular rule format. Identification of security rule formats with additional or alternative sections than actions, headers, and rule options is also anticipated. In some embodiments, for instance when the conversion system does not identify known syntax, tokens, or sections in the security rule, the conversion system can determine that the security rule does not have an identified format. If the conversion system is able to identify a format of the security rule, operational flow proceeds to block 206. Otherwise, if the conversion system is not able to identify a format of the security rule, operational flow proceeds to block 207.

At block 206, the conversion system validates syntax of the security rule. For instance, the conversion system can store regular expressions for the corresponding format and can check that the security rule satisfies one of the regular expressions, wherein the regular expression corresponds to valid syntax for the rule format. Additionally, the conversion system can determine whether tokens at particular sections of the security rule (for instance, as extracted from the security rule by a regular expression) are valid tokens for the rule format. If the conversion system determines that the security rule has valid syntax, operational flow proceeds to block 208. Otherwise, if the conversion system determines that the security rule has invalid syntax, operational flow proceeds to block 207. At block 207, the conversion system generates a user alert indicating invalid syntax for the security rule and operational flow continues to block 216.

At block 208, the conversion system converts the security rule from its existing format to a target format with token/pattern mappings. Operations at block 208 for converting security rules between formats are described in greater detail in reference to FIG. 3.

At block 210, the conversion system tests the converted security rule with traffic logs and pattern analysis. Testing the converted security rule with traffic logs comprises deploying the converted security rule on a live firewall and/or a firewall running in a virtual environment and determining an FPR and FNR of matches of the security rule on traffic logs when compared to matches of the security rule pre-conversion. Accordingly, the conversion system can deploy both the pre- and post-conversion security rules on the firewall to determine FPR and FNR of matches. The traffic logs can comprise industry standard traffic logs (e.g., traffic logs for known vulnerabilities stored in public repositories) and/or traffic logs in a deployment environment of a user that requested the rule conversion.

Testing the converted security rule with pattern analysis comprises determining whether each pattern is too short/long and/or determining whether the matching range of each pattern within the converted security rule is too small/large. Determining whether each pattern is too short and/or long can be based on a rules engine for the target rule format that has upper and lower threshold lengths. Additionally, the conversion system can have threshold matching ranges patterns. The conversion system can determine whether patterns are common patterns and can identify common patterns as potentially too broad during testing.

The conversion system can implement a subset of the above tests for the converted security rule. Accordingly, testing criteria to determine whether the converted security rule passes or fails can be any combination of criteria for passing any of the tests. If the converted security rule passes the test(s), operational flow proceeds to block 212. Otherwise, if the converted security rule fails the test(s), operational flow proceeds to block 214.

At block 212, the conversion system exports the converted security rule to the user. Operational flow proceeds to block 216 for converting additional security rules.

At block 214, the conversion system generates a user alert of performance deficiencies for the converted security rule based on failing tests and/or updates the converted security rule. If the conversion system updates the converted security rule, operational flow returns to block 210. Otherwise, operational flow proceeds to block 216. The connector between blocks 214 and 210 in FIG. 2 is depicted with a dashed line to indicate that this flow is optional and, in some embodiments, the converted security rule is not updated and instead a user alert indicating possible performance deficiencies of the converted security rule is generated.

At block 216, the conversion system continues iterating through security rules. If there is an additional security rule, operational flow returns to block 200. Otherwise, operational flow in FIG. 2 terminates.

FIG. 3 is a flowchart of example operations for converting a security rule from an existing format to a target format with token/pattern mappings. The example operations can implement block 208 of FIG. 2.

At block 300, the conversion system extracts tokens and corresponding patterns from the security rule. A subset of the tokens may correspond to an extracted pattern. Extraction of the tokens and corresponding patterns is according to the existing format. For instance, the conversion system can have a set of stored regular expressions for the existing format that indicate tokens to extract. Extracted tokens can additionally depend on the target format. For instance, for a pair of existing/target formats, certain sections may have identical syntax and can be omitted during token extraction.

At block 302, the conversion system identifies correlated sets of token(s) for mapping. Tokens are correlated according to the existing and target formats. For instance, a set of tokens can be logically associated as multiple related rule options, e.g., a directional flow rule option and a content rule option can be logically associated to denote that the content rule option applies for traffic with the provided directional flow. Additionally, the conversion system can determine that a combination of rule options for the existing format maps to multiple combinations of rule options for the target format and can correlate these multiple combinations of rule options. For instance, the target format may support multiple protocol field options such as normalized and unnormalized HTTP cookies in place of a single protocol field option for the existing format such as HTTP cookies, and as such tokens for normalized and unnormalized HTTP cookies can be correlated.

At block 304, the conversion system begins iterating through sets of token(s). FIG. 3 depicts analyzing mappings for performance deficiency as per set of token(s) from which the mappings were determined. Alternatively, the conversion system can first map sets of token(s) and populate the converted rule with the mapped sets of token(s), and then subsequently analyze the resulting converted rule for performance deficiencies.

At block 306, the conversion system determines the mapping of the set of token(s) from the existing format to the target format. The mapping can comprise a mapping of a combination of rule options for the set of token(s) to a set of token(s) for a corresponding combination of rule options for the target format. Alternatively, the mapping can be for actions and/or headers. In some instances, the set of token(s) is mapped to multiple set of token(s), for instance when a protocol field rule option in the existing format is mapped to multiple protocol field rule options in the target format. An example of a combination of rule options is a flow direction, a flow connection state (e.g., “established”), a pattern for content, and a protocol field for matching for the pattern.

At block 308, the conversion system analyzes the mapped set of token(s) and corresponding pattern(s) for performance. For instance, the conversion system can analyze mapped tokens to determine if a pattern needs to have its matching range tuned, i.e., the pattern corresponds to too many or too few protocol fields as indicated by mapped tokens (e.g., a pattern may have low likelihood of being in a TCP payload, so mapped tokens corresponding to this protocol field can be performance deficient). If the conversion system identifies performance deficient token(s) during its analysis, operational flow proceeds to block 310 and the conversion system removes the performance deficient token(s) from the mapped set of token(s). Otherwise, operational flow proceeds to block 312.

At block 312, the conversion system continues iterating through sets of token(s) to be mapped. If there is an additional set of token(s), operational flow returns to block 304. Otherwise, operational flow proceeds to block 314.

At block 314, the conversion system populates a converted rule with the mapped sets of token(s) and corresponding pattern(s) according to syntax of the target rule format. Syntax of the target rule format can comprise a template for the target rule format with fields for different types of tokens such as action tokens, header tokens, and rule option tokens. The rule options section of the template can comprise multiple sub-templates for different combinations of tokens in each mapped set of token(s). The conversion system analyzes patterns in the converted rule and, if there is a pattern(s) that is too short and/or long, operational flow proceeds to block 316. Otherwise, if the pattern(s) is the correct length, operational flow in FIG. 3 terminates.

At block 316, the conversion system shortens patterns that are too long and/or lengthens patterns that are too short in the converted rule. Shortening of patterns can comprise splitting patterns apart and lengthening patterns can comprise merging patterns and corresponding syntax/tokens in the converted rule according to the foregoing examples until each pattern is within a prescribed minimum length and maximum length, for instance as prescribed by a rules engine for the target rule format.

### Variations

The foregoing refers variously to SNORT and SURICATA rule formats. The example rule formats were chosen due to presentability of simple examples for rule conversion and tuning. Other rule formats such as OSSEC rules, ZEEK® rules, OSSIM rules, etc., and pairwise conversion between any two rule formats is additionally anticipated. The cybersecurity rule conversion systems depicted variously herein can be updated to handle new and/or previously unsupported rule formats by populating token mapping indexes and configuring syntax identification for the new rule formats. Additionally, for new rule formats more sophisticated rule conversions such as correlating multiple extracted tokens and identifying their intent, then mapping to one or more tokens of a target format having a similar or identical intent, is additionally anticipated. Rule conversion can be applied to rule formats for firewall rules in addition to IPS/IDS rules.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 204, 206, 207, 208, 210, 212, and 214 can be performed in parallel or concurrently across rule conversions. With respect to FIG. 2, flow from block 214 to 210 after updating a rule is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

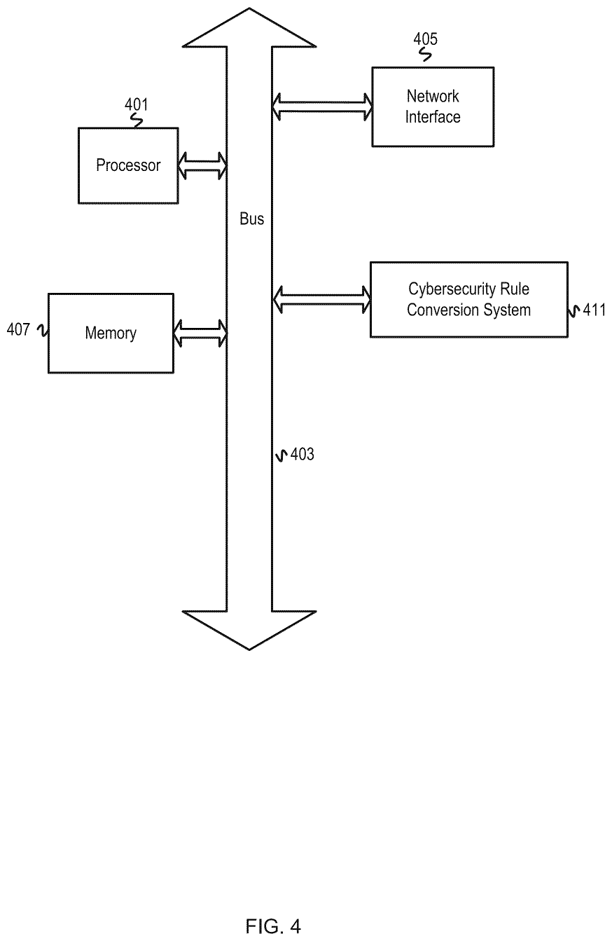

FIG. 4 depicts an example computer system with a cybersecurity rule conversion system. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes a cybersecurity rule conversion system (“conversion system”) 411. The conversion system 411 identifies and validates existing formats of IPS/IDS rules indicated for conversion. The conversion system 411 then extracts and maps tokens from the existing rules according to the existing format and target format. Subsequent to conversion, the conversion system 411 evaluates patterns for length and matching range of patterns in the converted rules for possible tuning. Finally, the conversion system 411 evaluates performance of the resulting converted rules based on pattern scope, pattern matching range, and performance of converted rules on traffic logs prior to exporting converted rules to users alongside indications of possible performance deficiencies. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
identifying a first format for a first security rule based, at least in part, on syntax of one or more documents that define the first security rule;
converting the first security rule from the first format to a second format to generate a second security rule based, at least in part, on first one or more patterns in the first security rule, wherein converting the first security rule comprises mapping first tokens of the first security rule corresponding to metadata of the first one or more patterns to second tokens of the second security rule, wherein the mappings are according to the first format and the second format; and
evaluating the second security rule for performance based, at least in part, on at least one of second one or more patterns in the second security rule and matches of the second security rule on traffic logs.

2. The method of claim 1, wherein converting the first security rule from the first format to the second format to generate the second security rule comprises:
for each pattern of at least a subset of the first one or more patterns, at least one of shortening and lengthening the pattern to generate second one or more patterns; and
forming the second security rule from the first security rule at least by replacing the least the subset of the first one or more patterns with the second one or more patterns.

3. The method of claim 2, further comprising identifying the at least the subset of the first one or more patterns based, at least in part, on lengths of each of the first one or more patterns.

4. The method of claim 1, wherein converting the first security rule from the first format to the second format to generate the second security rule comprises converting the first security rule according to one or more protocols indicated by the first security rule.

5. The method of claim 4, wherein the first tokens and the second tokens indicate at least one of fields of the one or more protocols and values of the fields of the one or more protocols.

6. The method of claim 5, wherein converting the first security rule from the first format to the second format to generate the second security rule further comprises removing a subset of the second tokens corresponding to protocol fields having wider matching ranges.

7. The method of claim 1, wherein evaluating the second security rule for performance comprises determining that the second security rule satisfies one or more performance criteria for the second one or more patterns in the second security rule and the matches of the second security rule on the traffic logs.

8. The method of claim 1, further comprising validating the syntax of the first security rule in the one or more documents according to the first format.

9. A non-transitory machine-readable medium having program code stored thereon, the program code comprising instructions to:
convert a first security rule having a first format to a second security rule having a second format based, at least in part, on first one or more patterns in the first security rule, wherein the program code to convert the first security rule to the second security rule comprises instructions to convert the first security rule to the second security rule according to mappings from first tokens in fields in the first security rule corresponding to metadata of the first one or more patterns to second tokens in fields of the second security rule, wherein the mappings are according to the first format and the second format; and
tune the second security rule for performance based on at least one of second one or more patterns in the second security rule and matches of the second security rule on traffic logs to generate a third security rule.

10. The non-transitory machine-readable medium of claim 9, wherein the program code to tune the second security rule comprises instructions to at least one of shorten and lengthen the at least one of the second one or more patterns.

11. The non-transitory machine-readable medium of claim 9, wherein the program code further comprises instructions to identify the second one or more patterns based, at least in part, on a false positive rate and a false negative rate of the matches of the second security rule on the traffic logs.

12. The non-transitory machine-readable medium of claim 9, wherein the program code to convert the first security rule having the first format to the second security rule having the second format comprises instructions to convert the first security rule to the second security rule according to one or more protocols indicated by the first security rule.

13. The non-transitory machine-readable medium of claim 12, wherein the first tokens and the second tokens indicate at least one of fields of the one or more protocols and values of the fields of the one or more protocols.

14. The non-transitory machine-readable medium of claim 13, wherein the program code to convert the first security rule to the second security rule according to one or more protocols indicated by the first security rule comprises program code to remove a subset of the second tokens that correspond to fields of the one or more protocols having wider matching ranges.

15. An apparatus comprising:
a processor; and
a machine-readable medium having instructions stored thereon that are executable by the processor to cause the apparatus to:
convert a first security rule having a first format to a second security rule having a second format based, at least in part, one first one or more patterns in the first security rule, wherein the instructions to convert the first security rule to the second security rule comprise instructions executable by the processor to cause the apparatus to map first tokens of the first security rule corresponding to metadata of the first one or more patterns to second tokens of the second security rule, wherein the mappings are according to the first format and the second format; and
evaluate the second security rule according to one or more performance criteria, wherein the one or more performance criteria are based on at least one of second one or more patterns in the second security rule and matches of the second security rule on traffic logs; and
based, at least in part, on the instructions executable by the processor to cause the apparatus to evaluate the second security rule according to the one or more performance criteria, tune the second security rule for performance on matches for the traffic logs.

16. The apparatus of claim 15, wherein the machine-readable medium further has stored thereon instructions executable by the processor to cause the apparatus to identify the second one or more patterns based, at least in part, on a false positive rate and a false negative rate of the matches of the second security rule on the traffic logs.

17. The apparatus of claim 15, wherein the instructions to convert the first security rule having the first format to the second security rule having the second format comprise instructions executable by the processor to cause the apparatus to convert the first security rule to the second security rule according to one or more protocols indicated by the first security rule.

18. The apparatus of claim 17, wherein the first tokens and the second tokens indicate at least one of fields of the one or more protocols and values of the fields of the one or more protocols.

19. The apparatus of claim 18, wherein the instructions to convert the first security rule to the second security rule according to one or more protocols indicated by the first security rule comprise instructions executable by the processor to cause the apparatus to remove a subset of the second tokens that correspond to fields of the one or more protocols having wider matching ranges.

20. The apparatus of claim 15, wherein the machine-readable medium further has stored thereon instructions executable by the processor to cause the apparatus to, identify the first format of the first security rule; and
validate syntax of the first security rule according to the first format.
